(19) United States
(12) Patent Application Publication
(10) Pub. No.: US 2021/0326401 A1
(43) Pub. Date: Oct. 21, 2021

(54) SCALING WORKLOADS USING STAGING AND COMPUTATION PUSHDOWN

(71) Applicant: Microsoft Technology Licensing, LLC, Redmond, WA (US)

(72) Inventors: Peter Chng, Sunnyvale, CA (US); Amol Ghoting, San Ramon, CA (US); Felix Giguere Villegas, San Francisco, CA (US); Gaojie Liu, San Jose, CA (US); Min Huang, San Jose, CA (US); Ashish Singhai, Los Altos, CA (US)

(21) Appl. No.: 16/852,115

(22) Filed: Apr. 17, 2020

(51) Int. Cl. G06F 16/9538; G06F 16/906; G06F 16/9536; G06N 3/04

(52) U.S. Cl. CPC G06F 16/9538; G06N 3/04; G06F 16/9536; G06F 16/906

(57) ABSTRACT

In some embodiments, a computer system generates offline a viewer embedding for a user of an online service based on a viewer portion of a scoring model using viewer features stored in a data source in association with a profile of the user, generates offline candidate embeddings for recommendation candidates by a key-value store based on a recommendation portion of the scoring model using features of the recommendation candidate stored in the key-value store, pushes the viewer embedding to the key-value store, generates online pairwise scores for recommendation candidates by the key-value store based on a pairwise portion of the scoring model using the viewer embedding and candidate embeddings, generates ranking scores for the recommendation candidates based on the scoring model using the embeddings and the pairwise scores, and causes recommendation candidates to be displayed on a device of the user based on the corresponding ranking scores.

### TECHNICAL FIELD

The present application relates generally to systems and methods, and computer program products for scaling large scale scoring workloads of an online service using staging and partial computation pushdown techniques.

### BACKGROUND

Certain online services provide recommendations of content to their users. In determining what content to recommend to different users, some computer systems of online services use a scoring model to evaluate different recommendation candidates, and then select one or more of the recommendations candidates for display to a viewer user. The scoring model may use features of the viewer user to whom the selected recommendations are to be display and corresponding features of each recommendation candidate to generate scores for the recommendation candidates, and then select one or more of the recommendation candidates based on the scores. Current solutions involve pulling the features of the viewer user and the features of the recommendation candidates from their respective data sources to another system component in order to generate the scores for the recommendation candidates. However, given the extremely large number of recommendation candidates to be scored, as well as the extremely large amount of feature data for each recommendation candidate, transmitting all of the features for all of the recommendation candidates to another system component consumes an excessive amount of network bandwidth. Additionally, the scoring of the recommendation candidates is computationally expensive and performing all of the computations of the scoring model in one system component is inefficient. As a result of these technical deficiencies, the functioning of the computer system of the online service is negatively affected. Other technical problems may arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 illustrates an operational flow of a recommendation system implementing staging to scale workloads in generating recommendations, in accordance with an example embodiment.

FIG. 4 illustrates an operational flow of the recommendation system pushing computation to a key-value store to scale workloads in generating recommendations, in accordance with an example embodiment.

FIG. 5 illustrates a graphical user interface (GUI) in which recommendations of other users selected using the recommendation system are displayed on a page corresponding to a user, in accordance with an example embodiment.

FIG. 6 illustrates a GUI in which recommendations of online job postings selected using the recommendation system are displayed on a page corresponding to a user, in accordance with an example embodiment.

FIG. 7 is a flowchart illustrating a method of generating recommendations using staging and computational pushdown to sale workloads, in accordance with an example embodiment.

FIG. 8 is a block diagram of an example computer system on which methodologies described herein may be executed, in accordance with an example embodiment.

### DETAILED DESCRIPTION

### I. Overview

Example methods and systems of scaling large scale scoring workloads of an online service using staging and partial computation pushdown techniques are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. The implementation of the features disclosed herein involves a non-generic, unconventional, and non-routine operation or combination of operations. In some example embodiments, a specially-configured computer system that generates recommendations using staging and computational pushdown to scale workloads in a way that reduces network bandwidth consumption and computational expense. For example, the computer system reduces network bandwidth consumption by pushing a viewer feature embedding to a key-value store for use with candidate feature embeddings of recommendation candidates in computation by the key-value store of a pairwise portion of a scoring model rather than pulling the candidate feature embedding of the recommendation candidates from the key-value store to an external system component for use in computation with the viewer feature embedding, thereby avoiding the heavy load on network bandwidth associated with transmitting the massive amount of data of the candidate feature embeddings.

Additionally, the computer system reduces real-time computational load by staging the computations of a scoring model, such that certain portions of a scoring model are pre-computed offline in advance of a recommendation request and other portions of the scoring model are computed online in real-time in response to the recommendation request. Furthermore, the staging of the computations can be configured and re-configured based on technical characteristics of the computer system, such as an amount of network traffic, in order to maximize processing efficiency. Other technical effects will be apparent from this disclosure as well.

### II. Detailed Example Embodiments

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

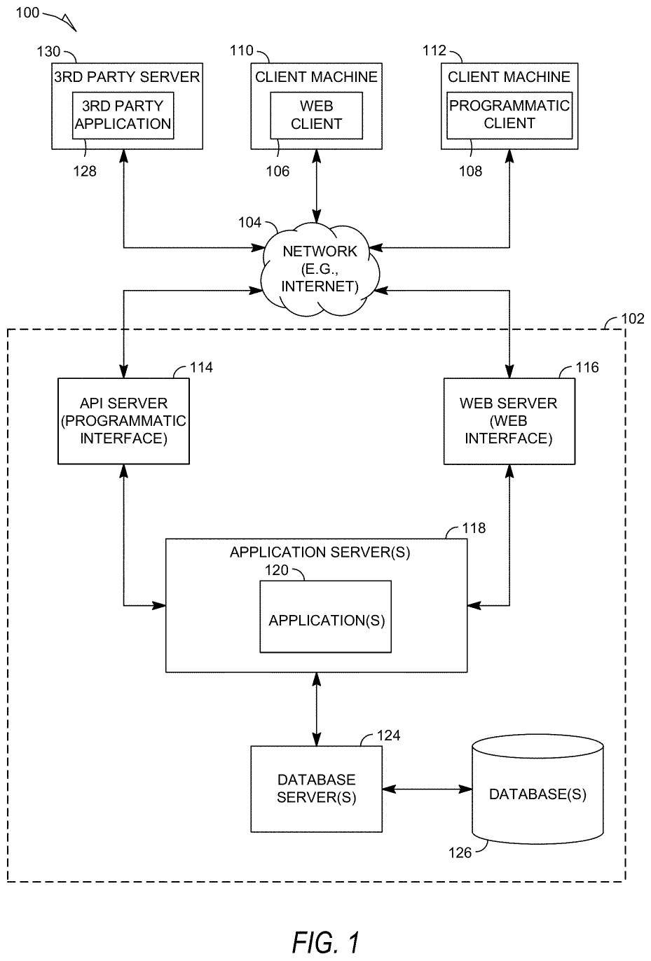

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third-party. The third-party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

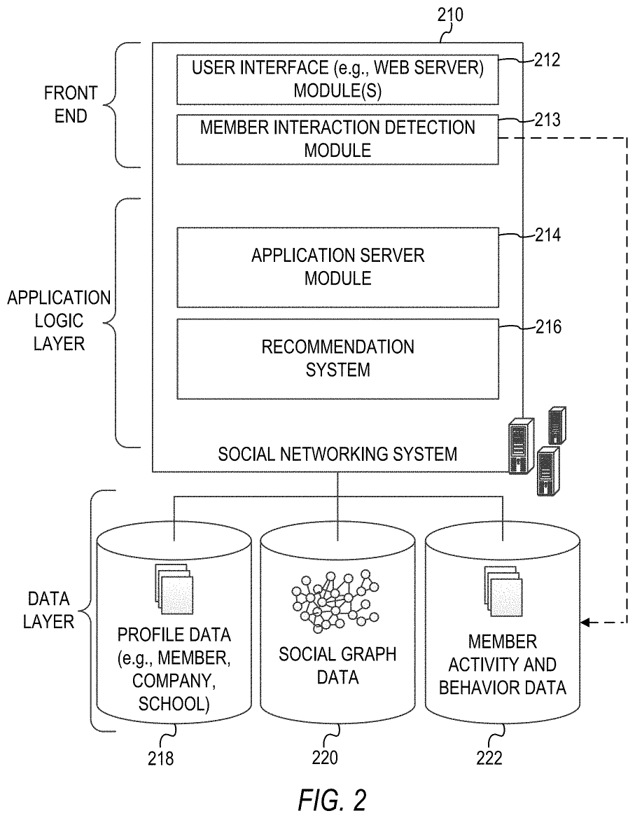

In some embodiments, the networked system 102 may comprise functional components of a social networking service. FIG. 2 is a block diagram showing the functional components of a social networking system 210, including a data processing module referred to herein as a recommendation system 216, for use in social networking system 210, consistent with some embodiments of the present disclosure. In some embodiments, the recommendation system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the recommendation system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the recommendation system 216. The members' interactions and behavior may also be tracked, stored, and used by the recommendation system 216 residing on a client device, such as within a browser of the client device, as will be discussed in further detail below.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third-party applications and services.

Although the recommendation system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

In some embodiments, the recommendation system 216 resides on a computer system, or other machine, having a memory and at least one processor (not shown). The recommendation system 216 may be incorporated into the networked system 102, such as in the application server(s) 118 in FIG. 1. In some example embodiments, the recommendation system 216 includes, or is otherwise in communication with, any combination of one or more of databases 218, 220, and 222 in FIG. 2. Other configurations of the recommendation system 216 are also within the scope of the present disclosure.

In some example embodiments, the recommendation system 216 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, the recommendation system 216 is configured to receive user input. For example, the recommendation system 216 can present one or more GUI elements (e.g., drop-down menu, selectable buttons, text field) with which a user can submit input.

In some example embodiments, the recommendation system 216 is configured to perform various communication functions to facilitate the functionality described herein, such as by communicating with the social networking system 210 via the network 104 using a wired or wireless connection. The recommendation system 216 may also provide various web services or functions, such as retrieving information from the third party servers 130 and the social networking system 210. Information retrieved by the recommendation system 216 may include profile data corresponding to users and members of the social networking service of the social networking system 210.

Additionally, the recommendation system 216 can provide various data functionality, such as exchanging information with databases or servers. For example, the recommendation system 216 can access member profiles that include profile data from databases, such as from the database 218, as well as extract attributes and/or characteristics from the profile data of member profiles. Furthermore, the recommendation system 216 can access social graph data and member activity and behavior data from databases, such as the databases 220 and 222, as well as exchange information with third party servers 130, client machines 110, 112, and other sources of information.

In some example embodiments, the recommendation system 216 is configured to generate a corresponding ranking score for each one of a plurality of recommendation candidates based on a scoring model using a viewer feature embedding for a viewer user, a corresponding candidate feature embedding for the recommendation candidate, and a corresponding pairwise score of the recommendation candidate. The recommendation system 216 may then select at least one of the plurality of recommendation candidates to be displayed on a computing device of the viewer user as part of a function of the online service based on the corresponding ranking score of each one of the at least one of the plurality recommendation candidates. For example, the recommendation system 216 may rank the plurality of recommendation candidates based on their corresponding ranking scores, such as in ascending order or in descending order, and then select the top N-ranked recommendation candidates (e.g., top five ranked recommendation candidates) for display on the computing device of the viewer user, where N is a positive integer. However, it is contemplated that the recommendation system 216 may select the recommendation candidate(s) for display in other ways as well.

In some example embodiments, the scoring model comprises a combination of a logistic regression model and a deep neural network model. The deep neural network model may comprise a viewer portion configured to generate a viewer feature embedding for the viewer user using a plurality of viewer features stored in a data source in association with a profile of the viewer user. For example, the viewer portion of the scoring model may be configured to generate the viewer feature embedding using any of the data of the viewer user stored in any of the databases 218 (e.g., profile data), 220 (e.g., social graph data), and 222 (e.g., behaviour data).

The deep neural network model may also comprise a recommendation portion configured to generate a corresponding candidate feature embedding for each one of a plurality of recommendation candidates using a corresponding plurality of recommendation features of the recommendation candidate. For example, if the recommendation candidates are recommendations to connect with other users, then the recommendation features of each recommendation candidate may comprise the data stored in association with corresponding profiles of those other user, such as profile data, social graph data, and behaviour data. In another example, if the recommendation candidates are recommendations of online job postings, then the recommendation features of each recommendation candidate may comprise data stored in association with the corresponding online job posting, such as a job title, a job industry, a location of the job, and skills associated with the job. Other types of recommendation features are also within the scope of the present disclosure. The viewer feature embedding and the candidate feature embeddings disclosed herein may comprise vector representations of the corresponding viewer user and recommendation candidates, respectively.

The deep neural network model may further comprise a pairwise portion configured to generate a corresponding pairwise score for each recommendation candidate based using the viewer feature embedding and the corresponding candidate feature embedding of the recommendation candidate. For example, the viewer feature embedding and the candidate feature embeddings of the recommendation candidates may be fed from the viewer portion and the recommendation portion, respectively, into the pairwise portion of the scoring model to generate the pairwise scores for the recommendation candidates.

The logistic regression model of the scoring model may use the viewer feature embedding, the candidate feature embeddings, and the pairwise scores to generate corresponding ranking scores for the recommendation candidates. For example, the viewer feature embedding, the candidate feature embeddings, and the pairwise scores generated by the deep neural network model may be fed into the logistic regression model, which may then use the viewer feature embedding, the candidate feature embeddings, and the pairwise scores in generating the corresponding ranking scores.

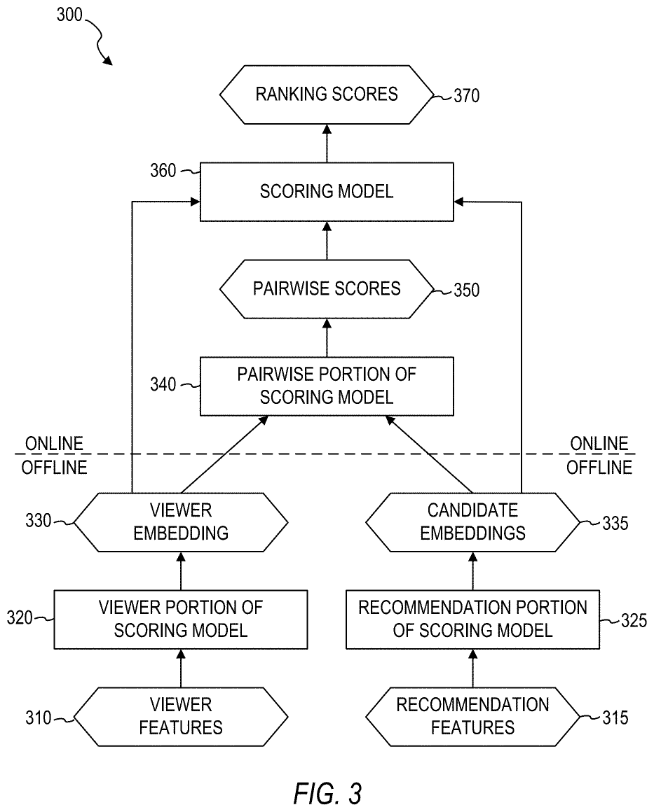

FIG. 3 illustrates an operational flow 300 of the recommendation system 216 implementing staging to scale workloads in generating recommendations, in accordance with an example embodiment. In the operational flow 300, the recommendation system 216 uses a viewer portion 320 of a scoring model 360 to generate a viewer feature embedding 330 for a viewer user of an online service based a plurality of viewer features 310 stored in a data source in association with a profile of the viewer user. The plurality of viewer features 310 may comprise any data stored in association with a profile of the viewer user, such as any of the data of the viewer user stored in any of the databases 218 (e.g., profile data), 220 (e.g., social graph data), and 222 (e.g., behaviour data).

The recommendation system 216 may also use a recommendation portion 325 of the scoring model 360 to generate a corresponding candidate feature embeddings 335 for a plurality of recommendation candidates based on corresponding recommendation features 315 of the recommendation candidates. As discussed above, the recommendation features may depend on the type of recommendation candidate. For example, if the recommendation candidates are recommendations to connect with other users, then the recommendation features of each recommendation candidate may comprise the data stored in association with corresponding profiles of those other user, such as profile data, social graph data, and behaviour data. In another example, if the recommendation candidates are recommendations of online job postings, then the recommendation features of each recommendation candidate may comprise data stored in association with the corresponding online job posting, such as a job title, a job industry, a location of the job, and skills associated with the job. Other types of recommendation features are also within the scope of the present disclosure.

In some example embodiments, the recommendation system 216 uses a pairwise portion 340 of the scoring model 360 to generate corresponding pairwise scores 350 for the plurality of recommendation candidates based on the viewer feature embedding 330 and the corresponding candidate feature embeddings 335 of the recommendation candidates. Since each pairwise score 350 is based on the viewer feature embedding 330 and the corresponding candidate feature embedding 335 of the corresponding recommendation candidate, the corresponding pairwise score 350 that is generated is specific to that combination of viewer user and recommendation candidate, thereby adding a layer of personalization and relevance to the scoring process. The generating of the corresponding pairwise score 350 may comprise calculating a level of similarity between the viewer feature embedding 330 and the corresponding candidate feature embedding 335 based on a similarity function, where the similarity function comprises one of a cosine similarity calculation, a dot product calculation, and a Hadamard product calculation. However, other ways of generating the corresponding pairwise score 350 are also within the scope of the present disclosure.

In some example embodiments, the recommendation system 216 uses the scoring model 360 to generate corresponding ranking scores 370 for the plurality of recommendation candidates based on the viewer feature embedding 330, the corresponding candidate feature embeddings 335 of the recommendation candidates, and the corresponding pairwise scores 350 of the recommendation candidates. For example, a logistic regression model of the scoring model 360 may use the viewer feature embedding 330, the candidate feature embeddings 335, and the pairwise scores 350, which may have been generated by a deep neural network model, to generate the corresponding ranking scores 370 for the recommendation candidates using logistic regression.

As seen in FIG. 3, certain computations of the scoring model 360 may be performed offline, while other computations of the scoring model 360 may be performed online in real-time in response to a recommendation request associated with the viewer user accessing the online service via a computing device (e.g., when the viewer user loads a landing page of the online service on the computing device), as represented by the dotted line dividing the offline stage of the operational flow 300 from the online stage of the operational flow. In some example embodiments, the computations involved in the generation of the viewer embedding 330 and the computations involved in the generation of the candidate feature embeddings 335 are performed offline, while the computations involved in the generation of the pairwise scores 350 and the computations involved in the generation of the ranking scores 370 are performed online in response in real-time in response to a recommendation request.

As previously discusses, in some example embodiments, the recommendation system 216 reduces network bandwidth consumption by pushing the viewer feature embedding 330 to a key-value store for use with candidate feature embeddings 335 of recommendation candidates in computation by the key-value store of the pairwise portion of a scoring model 340 rather than pulling the candidate feature embedding 335 of the recommendation candidates from the key-value store to an external system component for use in computation with the viewer feature embedding 330, thereby avoiding the heavy load on network bandwidth associated with transmitting the massive amount of data of the candidate feature embeddings 335.

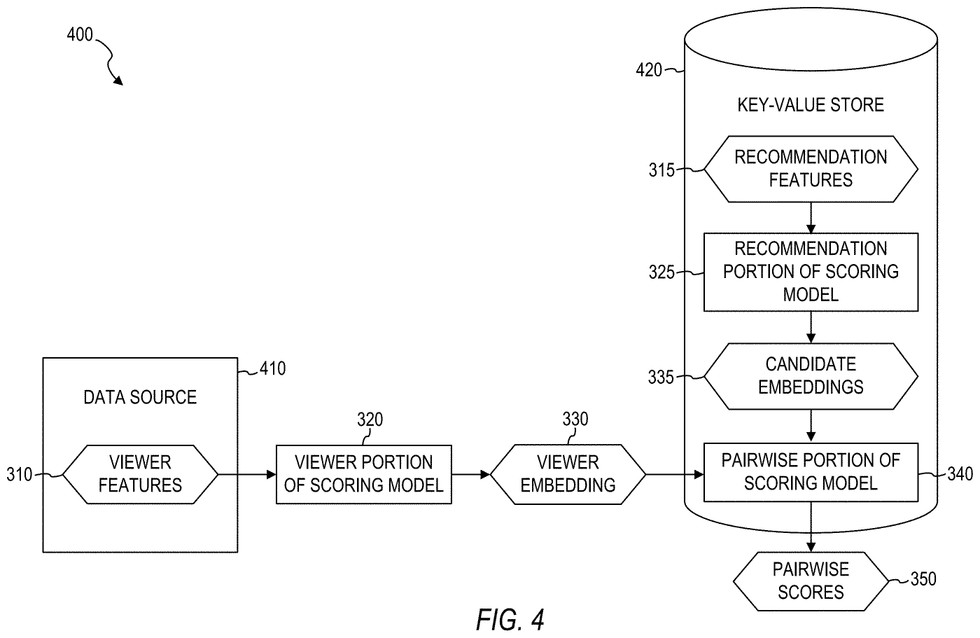

FIG. 4 illustrates an operational flow 400 of the recommendation system 216 pushing computation to a key-value store 420 to scale workloads in generating recommendations, in accordance with an example embodiment. As seen in FIG. 4, the operational flow 400 involves the viewer features 310 of a viewer user stored in a data source 410 and recommendation the recommendation features 315 of the recommendation candidates stored in the key-value store 420. In some example embodiments, the key-value store 420 comprises a type of nonrelational database that uses a key-value method to store data. The key-value store 420 may store data as a collection of key-value pairs in which a key serves as a unique identifier. Both keys and values can be anything, ranging from simple objects to complex compound objects. The key-value store 420 may be designed for storing, retrieving, and managing associative arrays, as well as a dictionary or hash table. Dictionaries contain a collection of objects, or records, which in turn have many different fields within them, each containing data. These records are stored and retrieved using a key that uniquely identifies the record and is used to find the data within the database. The key-value store 420 may be highly partitionable and allow horizontal scaling at extremely large scales.

In some example embodiments, the viewer features 310, which may be stored in a data source 410 separate and external from the key-value store 420, are fed into the viewer portion 320 of the scoring model 360 to generate the viewer feature embedding 330, while the recommendation features 315 stored in the key-value store 420 are fed into the recommendation portion 325 of the scoring model 360 to generate the candidate feature embeddings 335. As shown in FIG. 4, the generation of the candidate feature embeddings 335 is performed by the key-value store 420.

In some example embodiments, the viewer feature embedding 330 is pushed to the key-value store 420, where the viewer feature embedding 330 is fed into the pairwise portion of the scoring model 340 along with the candidate feature embeddings 335 to generate the pairwise scores 350 for the recommendation candidates. The key-value store 420 may comprise a distributed system, such that the corresponding pairwise scores 350 for the recommendation candidates are generated in parallel, thereby increasing the speed and efficiency of the recommendation system 216.

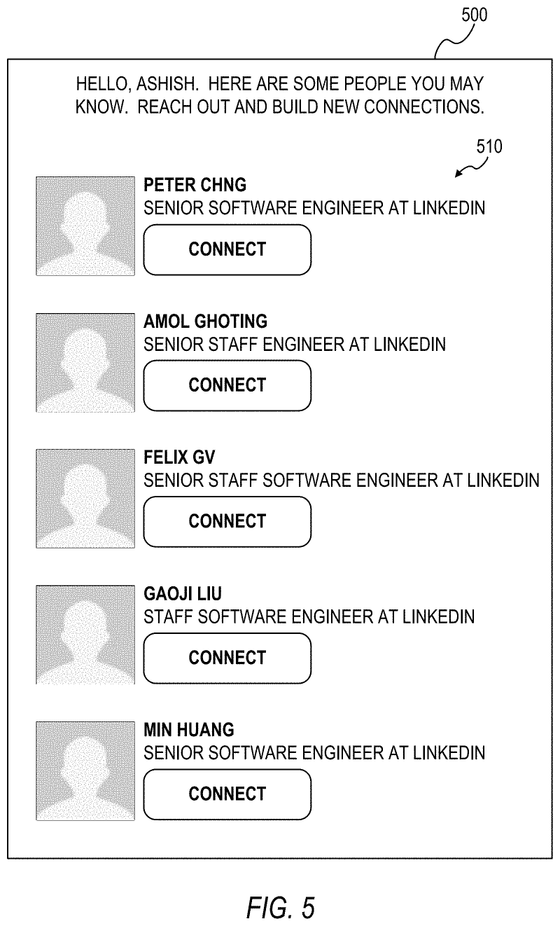

FIG. 5 illustrates a graphical user interface (GUI) 500 in which recommendations of other users selected using the recommendation system are displayed on a page corresponding to a user, in accordance with an example embodiment. In FIG. 5, the GUI 500 is presented to a user and displays selectable options 510 to send invitations to recommended other users to become connections on the social networking service. Each selectable option 510 may comprise an identification of the corresponding recommended other user, an image associated with a profile of the corresponding recommended other user, one or more attributes of the corresponding recommended other user (e.g., job position, company), and a selectable user interface element (e.g., a clickable “CONNECT” button) configured to cause a user-to-user message (e.g., an invitation to connect) to be transmitted to the corresponding recommended other user or to cause another type of user action to be performed. Each selectable option 510 may also comprise another selectable user interface element (not shown) configured to reject or otherwise dismiss the corresponding recommendation, so as to indicate an instruction by the user not to perform the user action for the corresponding recommended other user of the corresponding recommendation.

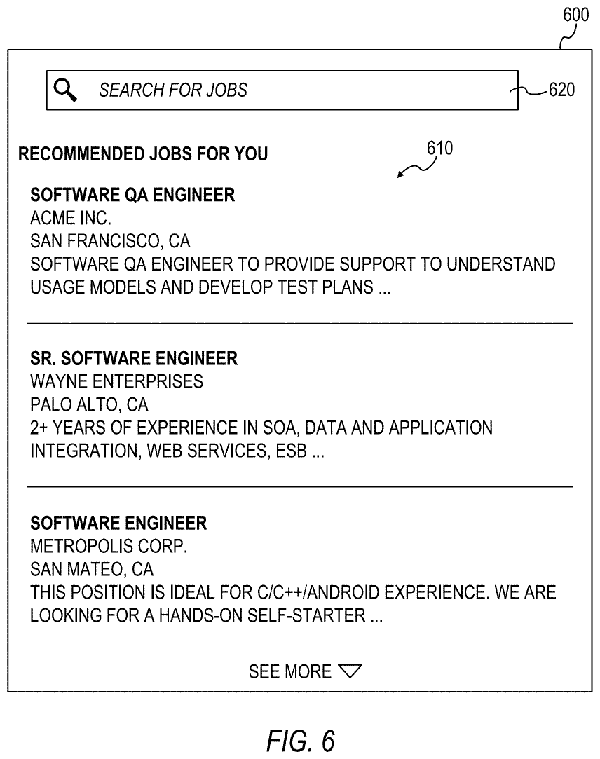

FIG. 6 illustrates a GUI 600 in which recommendations 610 of online job postings selected using the recommendation system are displayed on a page corresponding to a user, in accordance with an example embodiment. In some example embodiments, the online job postings are published on the online service, and the recommendations 610 are caused to be displayed to the user on the computing device of the user. The recommendations 610 may each comprise one or more corresponding selectable user interface elements (e.g., hyperlinked text) configured to display more information about the corresponding online job posting of the recommendation 610 (e.g., to view the entire online job posting rather than just an abbreviated summary of the online job posting) or to enable the user to perform some other type of online action directed towards the online job posting of the recommendation 610, such as saving the online job posting or applying to the online job posting. Each recommendation 610 may include information about the corresponding online job posting, such as a job title, a company name, a geographical location, and desired skills, educational background, and work experience. Other types of information may also be included in the recommendation 610. The GUI 600 may also display one or more user interface elements 620 configured to enable the user to submit a search query for searching for online job postings, such as by entering keyword search terms into a search field. In response to one or more keywords being submitted by the user as part of a search query via the search field, the recommendation system 216 may generate recommendations 610 based on the keyword(s) and feature data of online job postings being evaluated as search results.

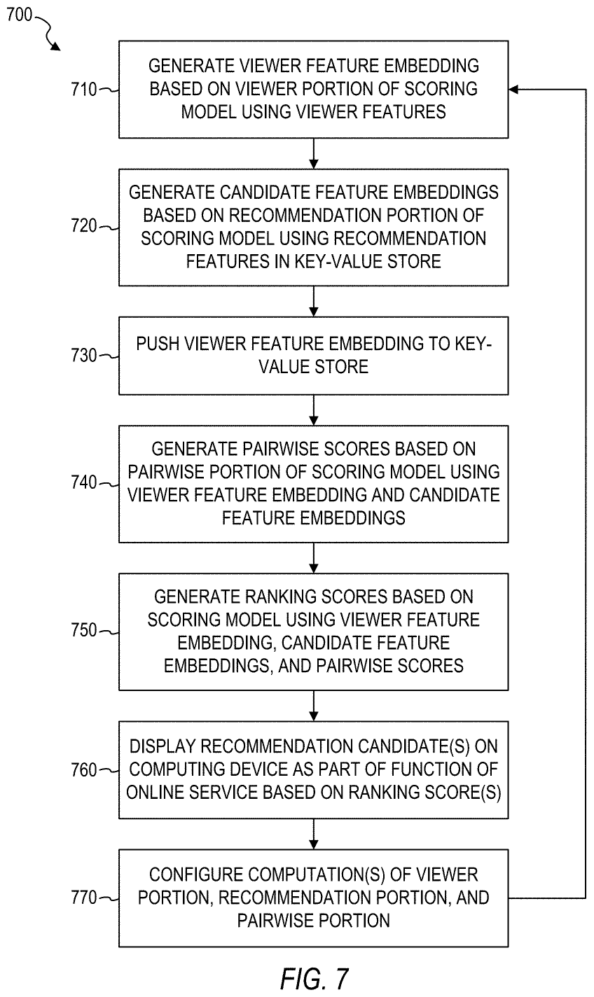

FIG. 7 is a flowchart illustrating a method 700 of generating recommendations using staging and computational pushdown to sale workloads, in accordance with an example embodiment. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the recommendation system 216 of FIG. 2, as described above.

At operation 710, the recommendation system 216 generates a viewer feature embedding for a viewer user of an online service based on a viewer portion of a scoring model using a plurality of viewer features stored in a data source in association with a profile of the viewer user. In some example embodiments, the generating of the viewer feature embedding is performed offline. The scoring model may comprise a combination of a logistic regression model and a deep neural network model, and the viewer feature embedding may be generated using the deep neural network model. However, other types of scoring models are also within the scope of the present disclosure. In some example embodiments, the plurality of viewer features comprises at least one of educational background data of the viewer user, employment history data of the viewer user, skill data of the viewer user, and social graph data of the viewer user. However, other types of viewer features are also within the scope of the present disclosure.

At operation 720, a key-value store of the recommendation system 216 generates a corresponding candidate feature embedding for each one of a plurality of recommendation candidates based on a recommendation portion of the scoring model using a corresponding plurality of recommendation features of the recommendation candidate stored in the key-value store. In some example embodiments, the generating of the corresponding candidate feature embedding is performed offline. The plurality of recommendation candidates may comprise at least one of a plurality of other users of the online service, a plurality of online job postings, and a plurality of content posted by other users of the online service. However, other types of recommendation candidates are also within the scope of the present disclosure. As discussed above with the viewer feature embedding, in some example embodiments, the scoring model comprises a combination of a logistic regression model and a deep neural network model, and the candidate feature embeddings may be generated using the deep neural network model.

At operation 730, the recommendation system 216 pushes the viewer feature embedding to the key-value store. For example, the recommendation system 216 may transmit the viewer feature embedding to the key-value store via a network connection. The key-value store is different from the data source. A key-value store is a data storage paradigm designed for storing, retrieving, and managing associative arrays, and a data structure more commonly known today as a dictionary or hash table. Dictionaries contain a collection of objects, or records, which in turn have many different fields within them, each containing data. These records are stored and retrieved using a key that uniquely identifies the record, and is used to find the data within the database.

At operation 740, the key-value store of the recommendation system 216 generates a corresponding pairwise score for each one of the plurality of recommendation candidates based on a pairwise portion of the scoring model using the viewer feature embedding and the corresponding candidate feature embedding of the recommendation candidate. In some example embodiments, the generating of the corresponding pairwise score is performed online in response to a recommendation request. In some example embodiments, the generating of the corresponding pairwise score based on the pairwise portion of the scoring model comprises generating the corresponding pairwise score for the corresponding recommendation candidate based on a level of similarity between the viewer feature embedding and the corresponding candidate feature embedding of the recommendation candidate. The generating of the corresponding pairwise score may comprise calculating the level of similarity based on a similarity function, where the similarity function comprises one of a cosine similarity calculation, a dot product calculation, and a Hadamard product calculation. However, other ways of generating the corresponding pairwise score are also within the scope of the present disclosure. In some example embodiments, the key-value store comprises a distributed system, and the corresponding pairwise scores for the plurality of recommendation candidates are generated in parallel. As discussed above with the viewer feature embedding and the candidate feature embeddings, in some example embodiments, the scoring model comprises a combination of a logistic regression model and a deep neural network model, and the pairwise scores may be generated using the deep neural network model.

At operation 750, the recommendation system 216 generates a corresponding ranking score for each one of the plurality of recommendation candidates based on the scoring model using the viewer feature embedding, the corresponding candidate feature embedding of the recommendation candidate, and the corresponding pairwise score of the recommendation candidate. For example, a logistic regression model of the scoring model may use the viewer feature embedding, the candidate feature embeddings, and the pairwise scores, which may have been generated by a deep neural network model, to generate corresponding ranking scores for the recommendation candidates using logistic regression, as previously discussed.

At operation 760, the recommendation system 216 causes at least one of the plurality of recommendation candidates to be displayed on a computing device of the viewer user as part of a function of the online service based on the corresponding ranking score of each one of the at least one of the plurality recommendation candidates. For example, the recommendation system 216 may rank the plurality of recommendation candidates based on their corresponding ranking scores, such as in ascending order or in descending order, and then select the top N-ranked recommendation candidates (e.g., top five ranked recommendation candidates) for display on the computing device of the viewer user, where N is a positive integer. However, it is contemplated that the recommendation system 216 may select the recommendation candidate(s) for display in other ways as well.

At operation 770, the recommendation system 216 configures a first set of one or more computations for the viewer portion of the scoring model, a second set of one or more computations for the recommendation portion of the scoring model, and a third set of one or more computations for the pairwise portion of the scoring model based one or more factors. For example, the recommendation system 216 may determine, based on the one or more factors, which computations of the scoring model are performed offline and which computations of the scoring model are performed online in response to a recommendation request.

One example of a factor that may be used to determine the configuration of the computations of the scoring model is a classification of the viewer user. In some example embodiments, the recommendation system 216 determines the configuration of which computations of the scoring model to perform offline and which computations of the scoring model to perform offline based on the classification of the viewer user. For example, the recommendation system 216 may analyze behavioural data of the viewer to classify the viewer user as one of a high frequency user of the online service (e.g., a user that frequently interacts with the online service or frequently performs a particular online action on the online service), a medium frequency user of the online service (e.g., a user that moderately interacts with the online service or moderately performs the particular online action on the online service), and low frequency user of the online service (e.g., a user that infrequently interacts with the online service or infrequently performs the particular online action on the online service). The recommendation system 216 may then configure the portion of the computation to be performed offline in direct relationship with the frequency level of the viewer user, such that a majority of the computations are performed offline and a minority of the computations are performed online for a high frequency user, half of the computations are performed offline and the other half of the computations are performed online for a medium frequency user, and a minority of the computations are performed offline and a majority of the computations are performed online for a low frequency user. Other types of classifications of the user and other types of configurations of the computations of the scoring model are also within the scope of the present disclosure.

Another example of a factor that may be used to determine the configuration of the computations of the scoring model is an analysis of how one or more viewer users of the online service responded to recommendations generated using a previous configuration of the first set of one or more computations for the viewer portion of the scoring model, the second set of one or more computations for the recommendation portion of the scoring model, and the third set of one or more computations for the pairwise portion of the scoring model. For example, the recommendation system 216 may determine whether the percentage of times the viewer user performed a particular online action in response to being presented recommendations generated using the previous configuration of computations for the scoring model satisfies a minimum threshold level for responsiveness, and then reconfigure the computations in response to a determination that the minimum threshold level for responsiveness is not satisfied.

Yet another example of a factor that may be used to determine the configuration of the computations of the scoring model is an amount of network traffic of the computer system. For example, the recommendation system 216 may analyze historical network traffic data for different time periods, and then configure the computations of the scoring model based on the time period for which it will be used. While online computations are often times more accurate and relevant than offline computations since they are less likely to be based on stale or otherwise irrelevant data, the recommendation system 216 may favour configuring more of the computations to be performed online than offline. However, the recommendation system 216 may throttle the majority of the computations back and forth between online and offline based on network bandwidth and traffic data. For example, when network traffic is determined to be low (e.g., below a particular traffic threshold level) for a particular time period, then the recommendation system 216 may configure a majority of the computations to be performed online during that particular time period, and conversely configure the majority of the computations to be performed offline during another particular time period for which the network traffic is determined to be high (e.g., above a particular traffic threshold level).

Other factors on which the recommendation system 216 may base its determination of which computations of the scoring model are performed offline and which computations of the scoring model are performed online are also within the scope of the present disclosure.

After configuration, or reconfiguration, of the computations of the scoring model at operation 770, the recommendation system 216 may then repeat the method 700 by returning to operation 710.

It is contemplated that any of the other features described within the present disclosure can be incorporated into the method 700.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a processor configured using software, the processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

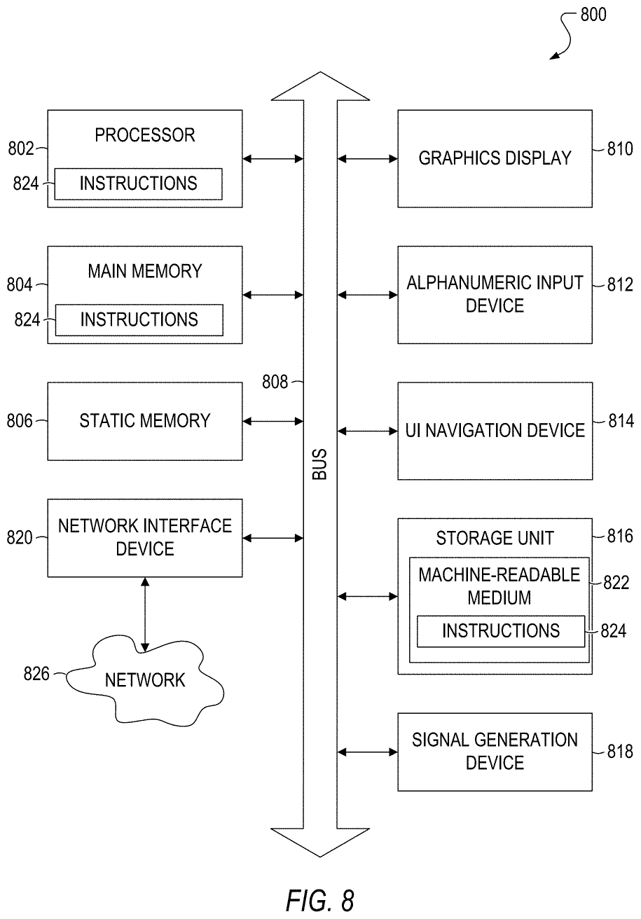

FIG. 8 is a block diagram of an example computer system 800 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a graphics display unit 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation device 814 (e.g., a mouse), a storage unit 816, a signal generation device 818 (e.g., a speaker) and a network interface device 820.

The storage unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions (e.g., instructions 824) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
generating, by a computer system, a viewer feature embedding for a viewer user of an online service based on a viewer portion of a scoring model using a plurality of viewer features stored in a data source in association with a profile of the viewer user, the generating of the viewer feature embedding being performed offline;
for each one of a plurality of recommendation candidates, generating, by a key-value store, a corresponding candidate feature embedding based on a recommendation portion of the scoring model using a corresponding plurality of recommendation features of the recommendation candidate stored in the key-value store, the generating of the corresponding candidate feature embedding being performed offline;
pushing, by the computer system, the viewer feature embedding to the key-value store, the key-value store being different from the data source;
for each one of the plurality of recommendation candidates, generating, by the key-value store, a corresponding pairwise score based on a pairwise portion of the scoring model using the viewer feature embedding and the corresponding candidate feature embedding of the recommendation candidate, the generating of the corresponding pairwise score being performed online in response to a recommendation request;
for each one of the plurality of recommendation candidates, generating, by the computer system, a corresponding ranking score based on the scoring model using the viewer feature embedding, the corresponding candidate feature embedding of the recommendation candidate, and the corresponding pairwise score of the recommendation candidate; and
causing, by the computer system, at least one of the plurality of recommendation candidates to be displayed on a computing device of the viewer user as part of a function of the online service based on the corresponding ranking score of each one of the at least one of the plurality recommendation candidates.

2. The computer-implemented method of claim 1, wherein the scoring model comprises a deep neural network model.

3. The computer-implemented method of claim 1, wherein the plurality of recommendation candidates comprises at least one of a plurality of other users of the online service, a plurality of online job postings, and a plurality of content posted by other users of the online service.

4. The computer-implemented method of claim 1, wherein generating of the corresponding pairwise score based on the pairwise portion of the scoring model comprises generating the corresponding pairwise score for the corresponding recommendation candidate based on a level of similarity between the viewer feature embedding and the corresponding candidate feature embedding of the recommendation candidate.

5. The computer-implemented method of claim 4, wherein the generating of the corresponding pairwise score comprises calculating the level of similarity based on a similarity function, the similarity function comprising one of a cosine similarity calculation, a dot product calculation, and a Hadamard product calculation.

6. The computer-implemented method of claim 1, wherein the plurality of viewer features comprises at least one of educational background data of the viewer user, employment history data of the viewer user, skill data of the viewer user, and social graph data of the viewer user.

7. The computer-implemented method of claim 1, further comprising configuring, by the computer system, a first set of one or more computations for the viewer portion of the scoring model, a second set of one or more computations for the recommendation portion of the scoring model, and a third set of one or more computations for the pairwise portion of the scoring model based on at least one of:
a classification of the viewer user;
an analysis of how one or more viewer users of the online service responded to recommendations generated using a previous configuration of the first set of one or more computations for the viewer portion of the scoring model, the second set of one or more computations for the recommendation portion of the scoring model, and the third set of one or more computations for the pairwise portion of the scoring model; and
an amount of network traffic of the computer system.

8. The computer-implemented method of claim 1, wherein the key-value store comprises a distributed system, and the corresponding pairwise scores for the plurality of recommendation candidates are generated in parallel.

9. A system comprising:
at least one hardware processor; and
a non-transitory machine-readable medium embodying a set of instructions that, when executed by the at least one hardware processor, cause the at least one processor to perform operations, the operations comprising:
generating, by a computer system, a viewer feature embedding for a viewer user of an online service based on a viewer portion of a scoring model using a plurality of viewer features stored in a data source in association with a profile of the viewer user, the generating of the viewer feature embedding being performed offline;
for each one of a plurality of recommendation candidates, generating, by a key-value store, a corresponding candidate feature embedding based on a recommendation portion of the scoring model using a corresponding plurality of recommendation features of the recommendation candidate stored in the key-value store, the generating of the corresponding candidate feature embedding being performed offline;
pushing, by the computer system, the viewer feature embedding to the key-value store, the key-value store being different from the data source;
for each one of the plurality of recommendation candidates, generating, by the key-value store, a corresponding pairwise score based on a pairwise portion of the scoring model using the viewer feature embedding and the corresponding candidate feature embedding of the recommendation candidate, the generating of the corresponding pairwise score being performed online in response to a recommendation request;
for each one of the plurality of recommendation candidates, generating, by the computer system, a corresponding ranking score based on the scoring model using the viewer feature embedding, the corresponding candidate feature embedding of the recommendation candidate, and the corresponding pairwise score of the recommendation candidate; and
causing, by the computer system, at least one of the plurality of recommendation candidates to be displayed on a computing device of the viewer user as part of a function of the online service based on the corresponding ranking score of each one of the at least one of the plurality recommendation candidates.

10. The system of claim 9, wherein the scoring model comprises a deep neural network model.

11. The system of claim 9, wherein the plurality of recommendation candidates comprises at least one of a plurality of other users of the online service, a plurality of online job postings, and a plurality of content posted by other users of the online service.

12. The system of claim 9, wherein generating of the corresponding pairwise score based on the pairwise portion of the scoring model comprises generating the corresponding pairwise score for the corresponding recommendation candidate based on a level of similarity between the viewer feature embedding and the corresponding candidate feature embedding of the recommendation candidate.

13. The system of claim 12, wherein the generating of the corresponding pairwise score comprises calculating the level of similarity based on a similarity function, the similarity function comprising one of a cosine similarity calculation, a dot product calculation, and a Hadamard product calculation.

14. The system of claim 9, wherein the plurality of viewer features comprises at least one of educational background data of the viewer user, employment history data of the viewer user, skill data of the viewer user, and social graph data of the viewer user.

15. The system of claim 9, wherein the operations further comprise configuring, by the computer system, a first set of one or more computations for the viewer portion of the scoring model, a second set of one or more computations for the recommendation portion of the scoring model, and a third set of one or more computations for the pairwise portion of the scoring model based on at least one of:
a classification of the viewer user;
an analysis of how one or more viewer users of the online service responded to recommendations generated using a previous configuration of the first set of one or more computations for the viewer portion of the scoring model, the second set of one or more computations for the recommendation portion of the scoring model, and the third set of one or more computations for the pairwise portion of the scoring model; and
an amount of network traffic of the computer system.

16. The system of claim 9, wherein the key-value store comprises a distributed system, and the corresponding pairwise scores for the plurality of recommendation candidates are generated in parallel.

17. A non-transitory machine-readable medium embodying a set of instructions that, when executed by at least one hardware processor, cause the processor to perform operations, the operations comprising:
generating, by a computer system, a viewer feature embedding for a viewer user of an online service based on a viewer portion of a scoring model using a plurality of viewer features stored in a data source in association with a profile of the viewer user, the generating of the viewer feature embedding being performed offline;
for each one of a plurality of recommendation candidates, generating, by a key-value store, a corresponding candidate feature embedding based on a recommendation portion of the scoring model using a corresponding plurality of recommendation features of the recommendation candidate stored in the key-value store, the generating of the corresponding candidate feature embedding being performed offline;
pushing, by the computer system, the viewer feature embedding to the key-value store, the key-value store being different from the data source;
for each one of the plurality of recommendation candidates, generating, by the key-value store, a corresponding pairwise score based on a pairwise portion of the scoring model using the viewer feature embedding and the corresponding candidate feature embedding of the recommendation candidate, the generating of the corresponding pairwise score being performed online in response to a recommendation request;
for each one of the plurality of recommendation candidates, generating, by the computer system, a corresponding ranking score based on the scoring model using the viewer feature embedding, the corresponding candidate feature embedding of the recommendation candidate, and the corresponding pairwise score of the recommendation candidate; and
causing, by the computer system, at least one of the plurality of recommendation candidates to be displayed on a computing device of the viewer user as part of a function of the online service based on the corresponding ranking score of each one of the at least one of the plurality recommendation candidates.

18. The non-transitory machine-readable medium of claim 17, wherein the scoring model comprises a deep neural network model.

19. The non-transitory machine-readable medium of claim 17, wherein the plurality of recommendation candidates comprises at least one of a plurality of other users of the online service, a plurality of online job postings, and a plurality of content posted by other users of the online service.

20. The non-transitory machine-readable medium of claim 17, wherein generating of the corresponding pairwise score based on the pairwise portion of the scoring model comprises generating the corresponding pairwise score for the corresponding recommendation candidate based on a level of similarity between the viewer feature embedding and the corresponding candidate feature embedding of the recommendation candidate.
